(19) United States
(12) Patent Application Publication
(10) Pub. No.: US 2004/0242080 A1
(43) Pub. Date: Dec. 2, 2004

(54) Electrical connection system

(75) Inventor: Matthew J. Lindenbaum, Ottawa, IL (US)

Correspondence Address: Joseph F. Hertz, Brinks Hofer Gilson & Lione, P.O. Box 10395, Chicago, IL, 60610, US

(73) Assignee: Lindenbaum Electrical Company, Inc.

(21) Appl. No.: 10/449,399

(22) Filed: May 29, 2003

(51) Int. Cl. H01R 9/22

(52) U.S. Cl. 439/709

(57) ABSTRACT

An electrical connection device has a mounting mechanism and a clamping mechanism. The mounting mechanism connects a supply wire to one or more branch wires in an electrical connection network. The clamping mechanism holds or secures the supply and branch wires to the electrical connection device. The electrical connection device may be part of an electrical connection network having a main panel and one or more electrical output devices. The main panel is connected to the electrical connection device by the supply wire. The electrical output devices each are connected to the electrical connection device by the branch wires.

### FIELD OF THE INVENTION

This invention generally relates to electrical connection systems for providing electricity in a building. More particularly, this invention relates to electrical connection systems having a terminal or junction box.

### BACKGROUND OF THE INVENTION

Many buildings have electricity available in one or more rooms. Buildings include houses, offices, and the like. The building typically has a network of wires to provide electricity from a main panel to the electrical outlets and/or switches in each room. Each wire usually has a ground and two insulated conductors encased in a polyvinylchloride (PVC) jacket. The insulated conductors may be color-coded for easier identification. The main panel generally is connected by a main wire through a meter to the electrical distribution system of an electric utility.

The network of wires usually is segmented into circuits or groups of outlets and/or switches for supplying electricity to lamps, appliances, and other electrical devices. Each circuit has a separate wire network to connect the outlets and/or switches in the circuit to a particular fuse or circuit breaker in the main panel. The fuse or circuit breaker controls the supply of electricity to the circuit and can shut-off the electricity should the circuit overheat. The electricity in a circuit usually has a potential of about 110 volts to about 120 volts or about 220 volts to about 240 volts. The electricity in a circuit usually has a current of about 5 amperes to about 50 amperes. A circuit may use other potentials and/or currents.

The wire network of a circuit generally has a branch wire connecting each outlet or switch in a junction box. A supply wire connects the branch wires in the junction box to the fuse or circuit breaker in the main panel. The junction box may be used for one of the outlets or switches in the circuit. At the junction box, the branch and supply wires are joined so that the outlets and/or switches in the circuit can receive electricity from the main panel. The PVC jacket is stripped or removed from the end of each wire. The insulation also is stripped or removed from the end of each insulated conductor. The corresponding insulated conductors of the branch and supply wires are coupled as well as their grounds. The wires may be joined by various means including twisting or lacing the conductors, soldering the conductors, mechanically joining the conductors with wire nuts, or a combination. Once the conductors are coupled, the connections usually are covered with electrical tape or another type of insulator. The coupling of conductors becomes more complex when a circuit has more outlets and/or switches. The connections also can separate over time, which may cause arcing, short circuits, and one or more of the outlets and/or switches to become inoperable.

Some wire networks use a terminal box for connecting the branch and supply wires. A terminal box usually has conductive bus bars embedded in a non-conductive box. The terminal box forms multiple compartments with each compartment having a longitudinal passageway aligned with wire receiving bores on the bus bars. When the supply and branch wires of a circuit are connected to the terminal box, the PVC jacket is stripped or removed from the end of each wire. The insulation also is stripped or removed from the end of each insulated conductor. The supply wire is inserted into one compartment of the terminal box. The ground and insulated conductors of the supply wire extend through the longitudinal passageway into the respective wire receiving bores of the bus bars. Each branch wire is inserted similarly into a separate compartment of the terminal box. The ground and insulated conductors of each branch wire also extend through the longitudinal passageway into the respective wire receiving bores for the bus bars. The grounds and insulated conductors are secured in the wire receiving bores by set screws. The bus bars connect the respective grounds and insulated conductors of each branch wire with the ground and insulated conductors of the supply wire. The proper insertion of the grounds and insulated conductors into the wire receiving bores may be time-consuming and thus may increase installation costs. In addition, the set screws may not secure the grounds and insulated conductors adequately in the wire receiving bores.

### SUMMARY

This invention provides an electrical connection device having a mounting mechanism and a clamping mechanism. The mounting mechanism connects a supply wire to one or more branch wires in an electrical connection network. The supply wire connects the electrical connection device to a main panel. Each branch wire connects the electrical connection device to an electrical output device such as an outlet or a switch.

The clamping mechanism holds or secures the supply and branch wires to the electrical connection device.

The electrical connection network may have a main panel, an electrical connection device, and one or more electrical output devices. The electrical connection device has a mounting mechanism and a clamping mechanism and is connected to the main panel by a supply wire. The electrical output devices each are connected to the electrical connection device by a branch wire. The mounting mechanism connects the supply and branch wires. The clamping mechanism holds the supply and branch wires to the electrical connection device.

The electrical connection device may have a base and a cover. The base forms multiple chambers. Each chamber has a circuit notch with an outside saddle. The base also has an inside saddle in each chamber. The inside saddle is adjacent to the outside saddle. The cover is attached to the base and has a clamping bar that extends between the inside and outside saddles. The cover forms a cable notch for each chamber. The cable notch is disposed adjacent to the circuit notch.

The electrical connection device may have a base, one or more bus bars, and one or more connectors. The base forms at least one wire cell with a landing well. The bus bars are disposed within the base and have one or more legs, each with a landing flange. Each leg extends through the landing well to position the landing flange within the wiring cell. The landing flange conforms to the landing well. The connectors are attached to the landing flanges.

The electrical connection device may have a base, one or more bus bars, or more connectors, and a cover. The base forms a plurality of chambers. Each chamber has three wire cells and a circuit notch with an outside saddle. Each wire cell has a landing well. The base has an inside saddle in each chamber. The inside saddle is adjacent to the outside saddle. The bus bars are connected to the base. Each bus bar has a plurality of legs. Each leg has a landing flange and extends through one of the landing wells to position the landing flange within one of the wiring cells in each chamber. Each connector is attached to one of the landing flanges. The cover is attached to the base and has a clamping bar extending between the inside and outside saddles. The clamping bar forms a cable notch in each chamber. The cable notch is positioned adjacent to the circuit notch.

Other systems, methods, features, and advantages of the invention will be or will become apparent to one skilled in the art upon examination of the following figures and detailed description. All such additional systems, methods, features, and advantages are intended to be included within this description, within the scope of the invention, and protected by the accompanying claims.

### BRIEF DESCRIPTION OF THE FIGURES

The invention may be better understood with reference to the following figures and detailed description. The components in the figures are not necessarily to scale, emphasis being placed upon illustrating the principles of the invention. Moreover, like reference numerals in the figures designate corresponding parts throughout the different views.

FIG. 1 depicts a block diagram or flow chart of an electrical connection network.

FIG. 2 depicts a perspective view of an electrical connection device with a cover removed.

FIG. 3 depicts a top view of a base for the electrical connection device shown in FIG. 2.

FIG. 4 depicts a front view of the base shown in FIG. 3.

FIG. 5 depicts a side view of the base shown in FIG. 3.

FIG. 6 depicts a bottom view of a cover for the electrical connection device shown in FIG. 2.

FIG. 7 depicts a front view of the cover shown in FIG. 6.

FIG. 8 depicts a side view of the cover shown in FIG. 6.

FIG. 9 depicts a front perspective view of a bus bar for the electrical connection device shown in FIG. 2.

FIG. 10 depicts a front view of the bus bar shown in FIG. 9.

FIG. 11 depicts a top view of the bus bar shown in FIG. 9.

FIG. 12 depicts a side view of the bus bar shown in FIG. 9.

FIG. 13 depicts a bottom view of the base shown in FIG. 3.

FIG. 14 depicts a top view of a back plate for the base shown in FIG. 13.

FIG. 15 depicts a side view of the back plate shown in FIG. 14.

### DETAILED DESCRIPTION OF THE PREFERRED EMBODIMENTS

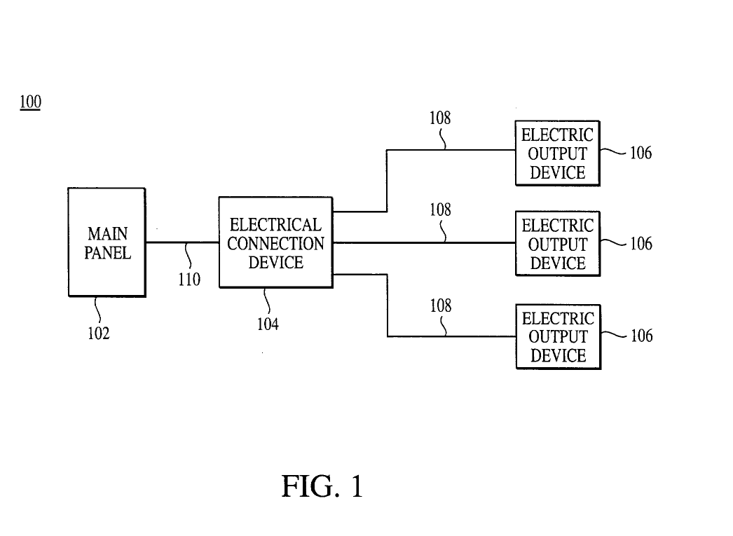

FIG. 1 depicts a block diagram or flow chart of an electrical connection network 100 having a main panel 102, an electrical connection device 104, and electric output devices 106. The electrical connection network 100 may be used to provide electricity to a building such as a home, office, or the like. The main panel 102 may be connected to an electric power source such as the electric distribution system of an electric utility or the like. The electric output devices 106 may be outlets, switches, a combination thereof, and the like. There may be fewer or additional electric output devices 106 connected to the electric connection device 104. Each of the electrical output devices 106 are connected to the electric connection device 104 by a branch wire 108. The electric connection device 104 is connected to a circuit breaker or a fuse in the main panel 102 by a supply wire 110. The branch and supply wires 108 and 110 each have a ground and two insulated conductors within a jacket. The insulated conductors may be color-coded. The jacket may be made of polyvinylchloride or another insulation material. The branch and supply wires 108 and 110 may have other configurations. The electric connection device 104 has mounting and clamping mechanisms. The mounting mechanism connects the branch wires 108 to the supply wire 110 through bus bars in the electric connection device. The clamping mechanism holds or secures the branch wires 108 and the supply wire 110 to the electric connector device 104. The electrical connection network 100 may have other configurations including those with fewer or additional components.

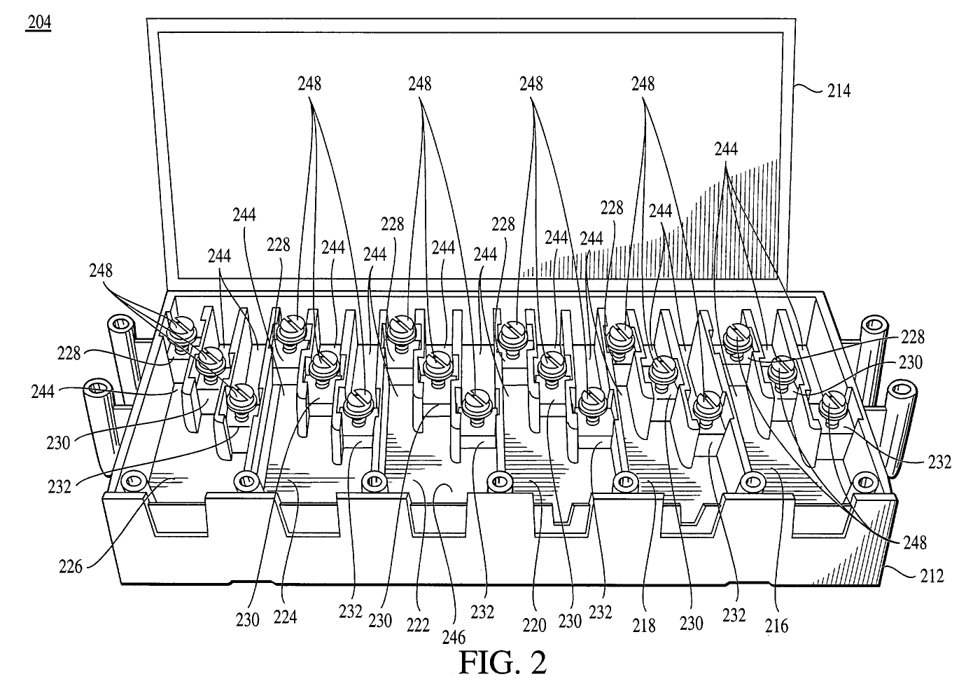

FIG. 2 depicts a perspective view of an electrical connection device 204 for an electrical connection network. The electrical connection device 204 has a base 212 and a cover 214. The base 212 forms chambers 216, 218, 220, 222, 224, and 226 where branch and supply wires (not shown) can be inserted for connection to bus bars 228, 230, and 232. Each chamber 216, 218, 220, 222, 224, and 226 has three wire cells 244. The base 212 may have fewer or additional chambers. The corresponding insulated conductors from each of the branch and supply wires are connected to one of the bus bars. The other corresponding insulated conductors for each of the branch and supply wires are connected to another one of the bus bars. The grounds from each of the branch and supply wires are connected to the other bus bar. The electrical connection device 204 has a mounting mechanism for connecting the grounds and insulated conductors of the branch and supply wires to the respective bus bars 228, 230, and 232. Each bus bar 228, 230, and 232 longitudinally transverses the base 212 beneath a cavity floor 246. Portions of each bus bar 228, 230, and 232 extend through the cavity floor 246 into the wire cells 244 of each chamber 216, 218, 220-, 222, 224, and 226. Each portion of a bus bar has a connector 248 connected to the bus bar. The connector 248 may be removable and/or adjustable such as a screw or bolt that attaches through a tapped or other hole in the portion of the bus bar. The connector 248 may be a hex head washer screw. The connector 248 may be configured dimensionally to improve the installation of the grounds and wires. The connector 248 may be stationary and/or fixed when set in place such as a rivet or similar mechanical device. Each of the branch and supply wires is disposed in a separate chamber with each of the grounds and insulated conductors extending into separate wire cells in the chamber. The connector 248 holds or compresses the insulated conductor or ground against the portion of the bus bar extending into the wire cell. When assembled, the cover 214 is attached to the base 212 above the chambers 216, 218, 220, 222, 224, and 226 and bus bars 228, 230, and 232. The cover 214 provides a clamping mechanism in combination with the base 212 to hold or secure the branch and supply wires to the electrical connection device 204. The base 212 and cover 214 may be injected molded from acrylonitrile butadiene styrene or other materials, including those with flame retarding characteristics. The electrical connection device 204 may have other configurations including those with fewer or additional components.

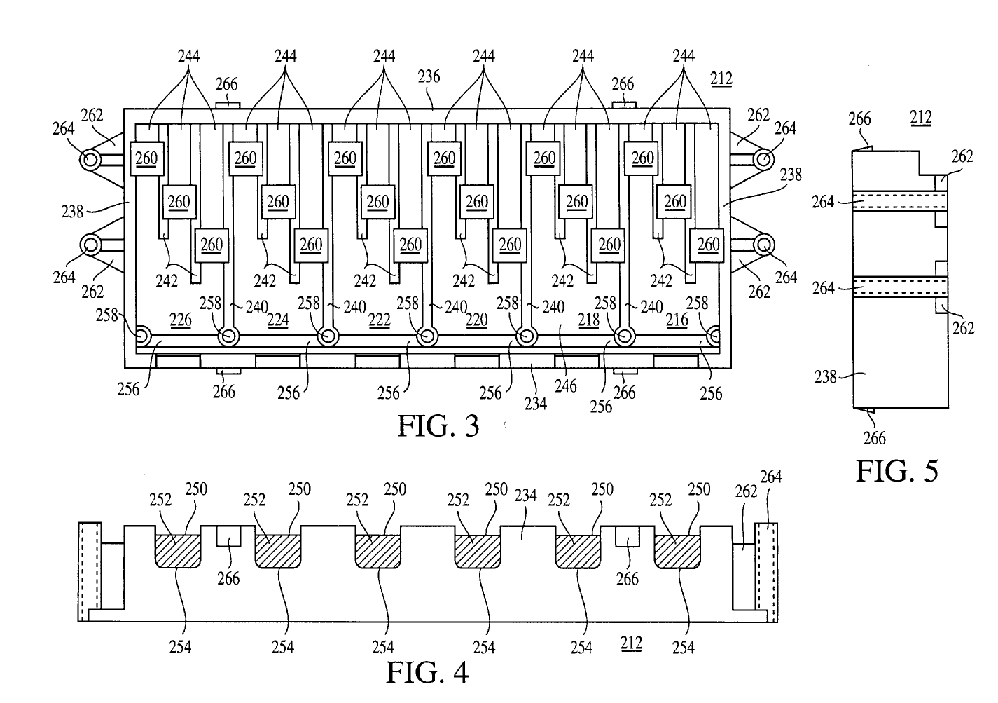

FIGS. 3-5 depict various views of the base 212 for the electrical connection device 204 shown in FIG. 3. The base 212 has a front wall 234, a back wall 236, side walls 238, separating walls 240, and a cavity floor 246, which are configured to form chambers 216, 218, 220, 222, 224, and 226. The base 212 has flanges 262 extending outside from the side walls 238. Each flange 262 has an attachment chamber 264 for receiving a nail, screw, or similar device to attach the base 212 to a wall or other location. The flanges 262 may have triangular configuration to improve strength. The base 212 also has locking clamps 266 extending from the front wall 234 and the back wall 236.

The base 212 has two insulating walls 242 in each chamber 216, 218, 220, 222, 224, and 226. The insulating walls 242 extend from the back wall 236 into each chamber 216, 218, 220, 222, 224 and 226. The insulating walls 242 may have the same or different lengths within a chamber and between the chambers. Each insulating wall 242 may extend across a portion or the entire chamber. The insulating walls 242 may have the same height or distance from the cavity floor 246 as the separating walls 240.

The insulating walls 242, back wall 236, side walls 238, and separating walls 240 form wire cells 244 in each chamber 216, 218, 220, 222, 224, and 226. The wire cells 244 are relatively open areas that allow for easier attachment of the grounds and conductors from the branch and supply wires to the bus bars. With these open areas, the insulation on the branch and supply can be stripped or removed to about the same length to reduce installation time. The insulating walls 242 and separating walls 240 insulate the chambers and thus the conductors and grounds from each other.

Each wire cell 244 has a landing well 260, which essentially is a cavity extending from the wire cell through the cavity floor 246. Each landing well 260 is configured to receive a portion of the respective bus bar for that landing well. The portion of the bus bar extends through the landing well 260 into the wire cell 244. The landing wells 260 may be configured to conform to the shape of the portion of the bus bar exerting into the wire wall. The landing wells 260 may have a square, rectangular, or circular shape. The landing wells 260 may have other shapes or different shapes between wire cells and between chambers. The landing wells 260 may have a staggered arrangement in each chamber. The landing wells 260 may be aligned or have other arrangements in each chamber.

Each chamber 215, 218, 220, 222, 224, and 226 has a circuit notch 250 with an outside saddle 254 formed in the front wall 234 of the base 212. The circuit notch 250 may be configured to confirm to the shape and/or size of the branch or supply wires so the wires have a more secure fit and less lateral movement. The circuit notch 250 may be filled partially or completely with a cutout web 252. One or more of the circuit notches 250 may not have a cutout web 252. Each cutout web 252 has a thinner cross-section than the front wall 234 for easier removal when a branch or supply wire is disposed in the chamber. The outside saddle 254 is substantially parallel to and extends from the cavity floor 246.

Each chamber 216, 218, 220, 222, 224, and 226 also has an inside saddle 256 extending from the cavity floor 246. The inside saddle 256 is substantially perpendicular to the cavity floor 246 and parallel to the outside saddle 254. The inside saddle 256 has substantially the same dimensions as the outside saddle 254. The respective side walls 238 and separating walls 240 have clamping chambers 258 formed on both sides of the inside saddle 256 that is in each chamber 216, 218, 220, 222, 224, and 226. The clamping chambers may be configured to receive a screw or other connection device. The clamping chambers 258 may be formed to connect with cavity floor 246, the inside saddle 256, a wall, or other components for additional strength.

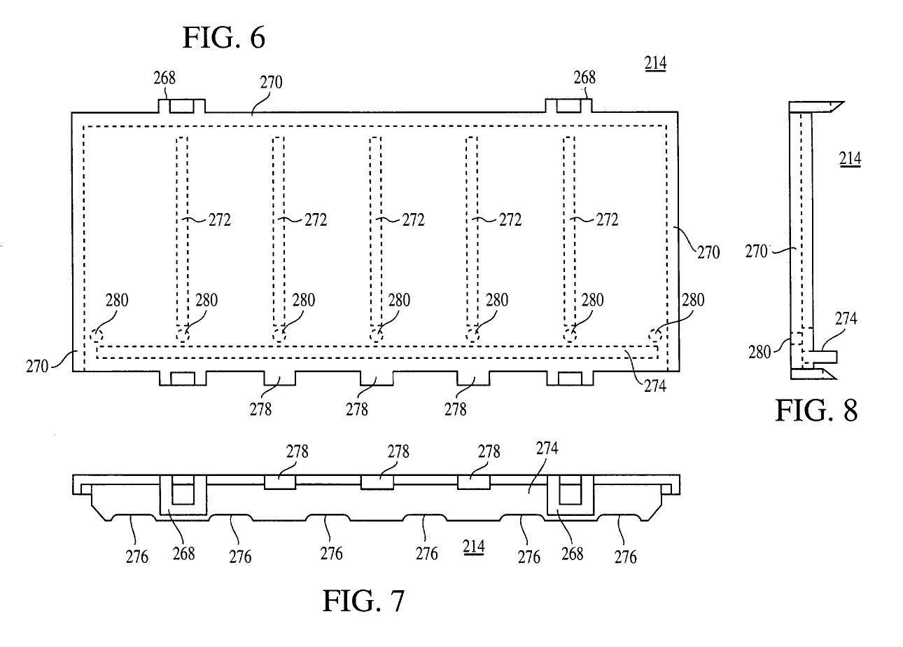

FIGS. 6-8 depict various views of the cover 214 for the electrical connection device 204. The cover 214 has an enclosure wall 270, stiffener ribs 272, clamping lugs 278, and locking latches 268. The cover 214 forms clamping holes 280 adjacent to the stiffener ribs 272 and the clamping legs 278.

When assembled with the base 212, the cover 214 rests upon the front wall 234, the back wall 236, and the side walls 238 with the enclosure wall 270 along the outside of the back and side walls. The stiffener ribs 272 are disposed adjacent to or on the separating walls 240. The stiffener ribs 272 and the separating walls 240 insulate the chambers and thus the grounds and insulated wires from each other. The clamping lugs 278 are disposed along the outside of the front wall 234. The clamping lugs 278 may be used to contain or otherwise hold the front wall 234 when the cover 214 is clamped on the base 212. The clamping holes 280 align with the clamping chambers 258. The locking latches 268 are operable to engage the locking clasps 266, thus holding or securing the cover 214 to the base 212.

The cover 214 also has a clamping bar 274 extending from the front. When assembled with the base 212, the clamping bar 274 extends along the inside of the front wall 234 at a location between the inside saddles 256 and the outside saddles 254. The clamping bar 274 has cable notches 276, which align with the circuit notches 250 in the base 212.

The electrical connection device 204 has a clamping mechanism to hold or secure the branch and supply wires. The clamping mechanism includes the inside saddle 256, the outside saddle 254, and the clamping bar 274. When the electrical connection device 204 is used, one or more branch and supply wires are positioned in the chambers 216, 218, 220, 222, 224, and 226 formed by the base 212. Each branch or supply wire extends into the respective chamber through the circuit notch 250. The branch or supply wire extends across both the inside saddle 256 and the outside saddle 254. The cable notches 276 on the clamping bar 274 engage the branch or supply wire from the side opposite of the saddles 254 and 256. Screws or other connector devices are placed through the clamping holes 280 into the clamping chamber 258 to secure or hold the cover 214 against the base 212. The cable notch 276 presses or biases the branch or supply wire against the inside saddle 256 and the outside saddle 254. The clamping mechanism also restricts the extraction of the branch and supply wires from the electrical connector device 204 by outside pulling or other forces.

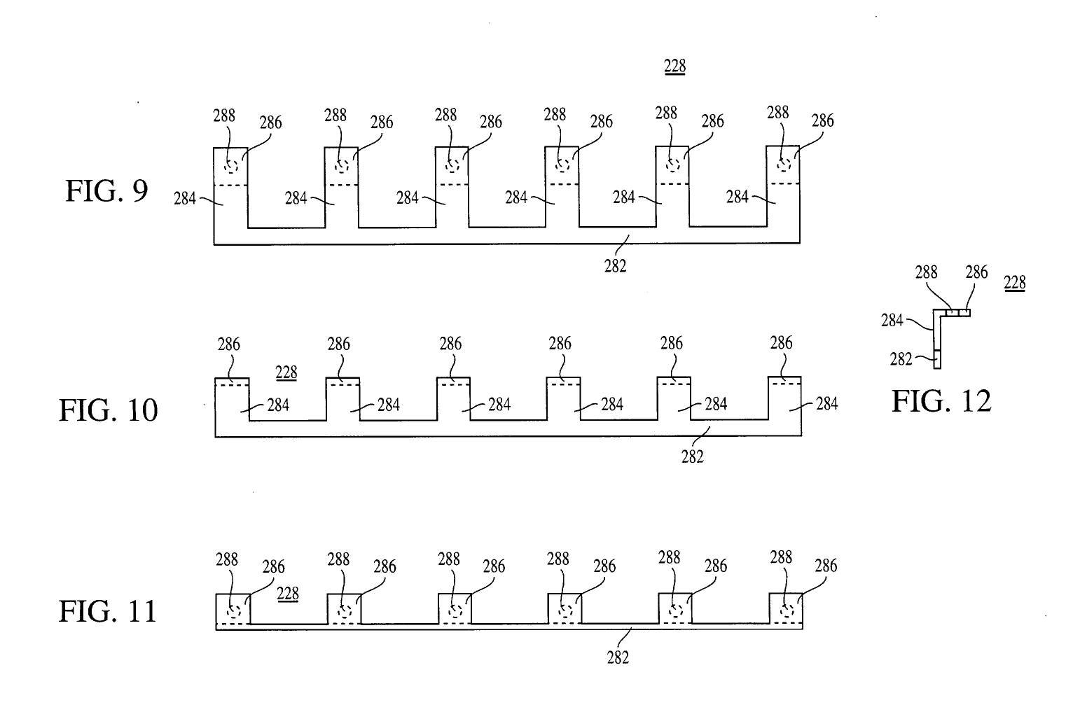

FIGS. 9-12 depict various views of a bus bar 228 for the electrical connection device 204. The bus bar 228 is the same as the bus bars 230 and 232. The bus bar 228 has a body 282 with legs 284, each extending to form a landing flange 286. The number of legs 284 corresponds to the number of chambers in the base 212. The legs 284 and landing flanges 286 are the portions of the bus bar that extend from beneath the cavity floor 246, through the landing wells 260, into the wire cells 244 of the base 212. Each landing flange 286 is substantially perpendicular to its respective leg 284 to reduce tilting of the bus bars 28, 30, and 32. The landing flanges 286 may be configured to conform with the insider perimeter of the landing wells 260. The landing flanges 286 may have a square, rectangular, circular, or other configuration. The landing flanges 286 each have a tapped hole 288 for receiving a connector such as a screw. The landing flanges 286 also may be sized to conform with the outside dimensions of the connector. The bus bar 228 may be made of copper, aluminum, or other conductive material. The bus bar 228 is configured to withstand the rated current for the electrical connection box 204. The bus bar 228 may be made by stamping, forming, and other manufacturing processes. The bus bars 228, 230, and 232 may have other or different configurations.

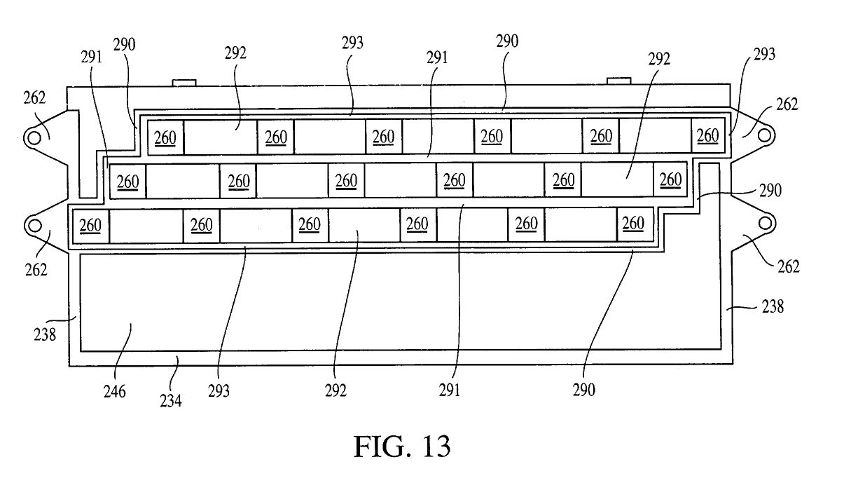

FIG. 13 depicts a bottom view of the base 212 for the electrical connection device 204. The base 212 has an outside wall 290 and bar insulating walls 291, which form bus bar cavities 292. The outside wall 290 has a ledge 293 along the inside perimeter. The body 282 of each bus bar 28, 30, and 32 is disposed within a separate bus bar cavity 292 of the base 212. The legs 284 of each bus bar extends through the landing wells 260 to position the flanges 286 in the wire cells 244 on the other side of the cavity floor 246.

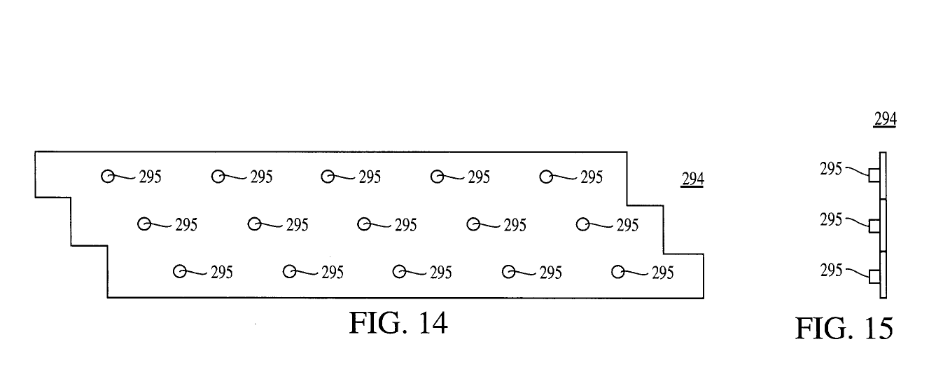

FIGS. 14 and 15 depict a back plate 294 for the base 212 of the electrical connection device 204. The back plate 294 is configured to conform to the inside perimeter of the outside wall 290 and to fit on the ledge 293. The back plate 294 is attached to the base 212, thus encapsulating and holding the bus bars 28, 30, and 32 within the base 212. The back plate 294 has stabilizers 295, which project from a common plane on the back plate 294. The stabilizers 295 are aligned with the bar cavities 292 when the back plate 294 is attached to the base 212. The stabilizers 295 are configured to hold the bus bars 28, 30, and 32 in place within the bus bar cavities 292. The stabilizers 295 support and position the body 282 of each bus bar 28, 30, and 32 against the bar insulating wall 291 or outside wall 290 of the respective bus bar cavity 292. With the body 282 of each bus bar 28, 30, and 32 disposed against one of the walls 290 or 291, the landing flanges 286 are positioned substantially parallel to the cavity floor 246 in each wire cell 244. The stabilizers 295 may have different shapes. There may be fewer or additional stabilizers 295. The back plate 294 may be attached to the base 212 by sonic welding, an adhesive, or another attachment means. The bus bars 28, 30, and 32 are installed after the base 212 is made and before the back plate 294 is attached to the base 212.

Various embodiments of the invention have been described and illustrated. However, the description and illustrations are by way of example only. Other embodiments and implementations are possible within the scope of this invention and will be apparent to those of ordinary skill in the art. Therefore, the invention is not limited to the specific details, representative embodiments, and illustrated examples in this description. Accordingly, the invention is not to be restricted except in light as necessitated by the accompanying claims and their equivalents.

What is claimed is:

1. An electrical connection network, comprising
a main panel;
an electrical connection device connected to the main panel by a supply wire, where the electrical connection device has a mounting mechanism and a clamping mechanism; and
at least one electrical output device each connected to the electrical connection device by a branch wire;
where the mounting mechanism connects the supply and branch wires, and
where the clamping mechanism holds the supply and branch wires to the electrical connection device.

2. The electrical connection network of claim 1, where the electrical connection device comprises:
a base forming a plurality of chambers, each chamber having three wire cells, each wire cell having a landing well;
a plurality of bus bars connected to the base, where each bus bar has a plurality of legs, where each leg has a landing flange and extends through one of the landing wells to dispose the landing flange within one of the wiring cells, where each landing flange has a connector; and
where the branch and supply wires are disposed in separate chambers;
where each of the branch and supply wires comprises a ground, a first conductor and a second conductor;
where the first conductor is disposed in a first wire cell, where a first connector compresses the first conductor against a first landing flange disposed in a first landing well;
where the second conductor is disposed in a second wire cell, where a second connector compresses the second conductor against a second landing flange disposed in a second landing well; and
where the ground is disposed in a third wire cell, where a third connector compresses ground against a third landing flange disposed in a third landing well.

3. The electrical connection network of claim 1, where the electrical connection device comprises:
a base forming a plurality of chambers, each chamber having a circuit notch with an outside saddle, where the base has an inside saddle in each chamber, where the inside saddle is adjacent to the outside saddle; and
a cover attached to the base, the cover having a clamping bar that extends between the inside and outside saddles, the cover forming a cable notch for each chamber, where the cable notch is disposed adjacent to the circuit notch;
where the supply wire is disposed through the circuit notch of one chamber and across the inside and outside saddles of the one chamber, where the cable notch of the one chamber biases the supply wire against the inside and outside saddles of the one chamber, and
where the branch wire is disposed through the circuit notch of another chamber and across other inside and outside saddles of the other chamber, where the cable notch of the other chamber biases the branch wire against the inside and outside saddles of the other chamber.

4. The electrical connection network of claim 3, further comprising:
at least one clamping screw,
where the base forms at least one clamping chamber next to each inside saddle,
where the cover forms at least one clamping hole that aligns with the at least one clamping chamber, and
where the at least one clamping screw is disposed in the at least one clamping hole and the at least one clamping chamber.

5. An electrical connection device, comprising
a base forming a plurality of chambers, each chamber having a circuit notch with an outside saddle, where the base has an inside saddle in each chamber, where the inside saddle is adjacent to the outside saddle; and
a cover attached to the base, the cover having a clamping bar that extends between the inside and outside saddles, the cover forming a cable notch for each chamber, where the cable notch is disposed adjacent to the circuit notch.

6. The electrical connector device of claim 5, where the base forms a cutout web in the circuit notch.

7. The electrical connection device of claim 5, further comprising:
at least one clamping screw,
where the base forms at least one clamping chamber next to the inside saddle,
where the cover forms at least one clamping hole that aligns with the at least one clamping chamber, and
where the at least one clamping screw is disposed in the at least one clamping hole and the at least one clamping chamber.

8. The electrical connection device of claim 5,
where the base has a front wall and at least one separating wall for forming the plurality of chambers, where the front wall forms the circuit notches with outside saddles;
where the cover has at least one stiffener rib aligned with the at least one separating wall, where the at least one stiffener rib and the at least one separating wall insulate the chambers from each other.

9. The electrical device of claim 8, where the cover has at least one clamping lug disposed on the front wall, the at least one clamping lug aligned with the at least one stiffener rib.

10. The electrical connection device of claim 5, further comprising a mounting mechanism.

11. An electrical connection device, comprising:
a base forming at least one wire cell with a landing well;
at least one bus bar connected to the base, the at least one bus bar having at least one leg with a landing flange, where the at least one leg extends through the landing well to dispose the landing flange within the wiring cell, where the landing flange is configured to conform to the landing well; and
a connector attached to each landing flange.

12. The electrical connector device of claim 11, where the connector is a hex head washer screw.

13. The electrical connection device of claim 12, where the hex head washer screw dimensionally conforms to the landing well.

14. The electrical connection device of claim 11, where the base forms a plurality of chambers, each chamber having a plurality of wire cells, each wire cell having a landing well.

15. The electrical connection device of claim 14, comprising a plurality of bus bars disposed within the base, each bus bar having a plurality of legs, each leg with a landing flange, where each leg extends through one of the landing wells to position the landing flange within one of the wire cells.

16. The electrical connection device of claim 15, where each chamber comprises three wire cells and where the plurality of bus bars comprises three bus bars.

17. The electrical device of claim 16, where the base forms six chambers.

18. The electrical device of claim 11, further comprising a cover, where the base and the cover have a clamping mechanism.

19. An electrical connection device, comprising:
a base forming a plurality of chambers, where each chamber has three wire cells and a circuit notch with an outside saddle, where each wire cell has a landing well, where the base has an inside saddle in each chamber, where the inside saddle is adjacent to the outside saddle;
a plurality of bus bars disposed within the base, each bus bar having a plurality of legs, each leg having a landing flange, where each leg extends through one of the landing wells to dispose the landing flange within one of the wiring cells in each chamber;
a plurality of connectors, each connector attached to one of the landing flanges; and
a cover attached to the base, where the cover has a clamping bar extending between the inside and outside saddles, where the clamping bar forms a cable notch in each chamber, where the cable notch is disposed adjacent to the circuit notch.

20. The electrical device of claim 19, where each landing flange conforms to the landing well, and where each connector conforms to the landing well.
